(19) United States
(12) Patent Application Publication
(10) Pub. No.: US 2012/0282887 A1
(43) Pub. Date: Nov. 8, 2012

(54) PERSONAL PROTECTION SYSTEM WITH AUTOMATIC EMERGENCY CONTACT NOTIFICATION BASED ON REGISTERED EVENTS

(76) Inventors: Chen Shiang Khoo, Kuala Lumpur (MY); Wai Lin Winnie Wong, Kuala Lumpur (MY)

(21) Appl. No.: 13/509,160

(22) PCT Filed: Oct. 12, 2010
(86) PCT No.: PCT/MY2010/000205

§ 371 Date: Jul. 26, 2012

(30) Foreign Application Priority Data
Nov. 11, 2009 (MY) PI 20094798

(51) Int. Cl. H04W 4/22

(52) U.S. Cl. 455/404.2

(57) ABSTRACT

The concept rides on the believed of ‘better be safe than sorry’ where the subscriber will register an event with anticipated end-time which the individual deems is vulnerable to cause her any potential harm. The event is then stored in a database with sufficient information for any emergency tracking and notification. At the end of the anticipated end time, a message will be sent from the server to the subscriber's wireless device requesting for safety confirmation, failing which the system will automatically send an alert notification message to a group of predefined emergency contacts through various channels and medias. The emergency message will also be posted to the subscriber's own social network services for mass notification. In addition, the subscriber has the option to trigger the location based tracking of his whole journey during the active event time if the individual wireless device is subscribed with the location base tracking system, such as global positioning system (GPS) service.

### FIELD OF INVENTION

The present invention relates to sending automatic emergency alert notifications to a pre-registered list of emergency contacts using various channels and media upon the execution of emergency events especially during a distress situation where one is in no capacity to call for rescue.

### BACKGROUND OF INVENTION

In today's world, we always seems to be reacting to an emergency and many a times it will always be too late and we can only grieve over the situation rather than being proactive and prevent the catastrophic event from happening.

Current emergency services come from the standard response to a 999 or 911 call where it will always require one to initiate a conscious call often during or after a distress situation conveying details of nature of the emergency and the location. Only then, can the emergency personnel dispatch the right help to the emergency location which often may be too late.

Often it is very difficult or challenging for one to initiate or finish an emergency call especially during an emergency distress situation. This usually resulted to the individual being deserted and left to resolve the emergency situation themselves.

With this method and service, one can take preventive action and be proactive in anticipating and registering any vulnerable emergency event upfront and without any further intervention or action from the individual especially during an emergency, the system will automatically detect, tracked the location of the individual and triggered for needed help.

This emergency event may also be a routine activity as vulnerability and mischief sometimes comes from the least expected routine activity which caught us off guard. As such, the ideal practice is to ensure that one register all the events every time the individual is going anywhere alone. To ease and make it seamlessly for an individual to register the event especially a routine event, the system provides standard routine templates during registration, thus making this a daily habit. Having cultivate this as one daily routine, this method will provide an almost full-proof ‘self-protection system’.

Today, there are many solutions or technology which enables one to trigger emergency notification to selected individuals in the event of an emergency. Take U.S. Pat. No. 5,742,666 to Alpert as an example, where the cellar phone automatically dials an emergency contact with a pre-registered message upon the user pushing a button on the phone. Alternatively, the user can also participate in an emergency call with the emergency contact upon a successful connection. However, this is limited to sending sequentially a fixed pre-recorded emergency audio to multiple users and does not provide much information of the emergency event or location.

U.S. Pat. No. 5,805,670 to Pons et al, on the other hand communicates 911 information such as location, telephone number and other information conveyed to the emergency operator and automatically send this information to pre-selected registered contacts using various channels such as wireless, facsimile and public data network.

However, this private notification system can only triggered the emergency notification when user successfully dialed into 911 emergency services which may not be the case when one is in danger.

U.S. Pat. No. 7,076,235 to Esque et al invention describes the notification of emergency contacts stored within the wireless device and upon and emergency input, the system will automatically retrieves the contacts and sends individual messages designated to individual contacts. Also, because the contacts are stored within the wireless device it is compatible to send messages to any wireless network transmitting by the wireless devices. Nevertheless, the said invention would still require one to push start the emergency button on the wireless device before automatically sending emergency notifications and does not provide much information of the emergency event.

U.S. Pat. No. 7,212,111 to Tupler et comprises of methods, systems and sensors in detecting an emergency situation such as heart attack and then automatically dispatching the related emergency services. Also, the system will retrieve additional emergency contacts from the memory wireless device to notify them that one has requested for emergency services. This invention is more relevant to triggering an emergency services outcome from a health or environment hazard where there is a change to the predefined threshold. However, it is limited by the availability of the types of sensors in place and does not provide much information of the emergency situation.

The above invention and technology are all designed to automatically sending emergency notifications to emergency contacts. However all inventions would require one to trigger an emergency call or emergency button on the wireless devices before reaching out to the emergency contacts for help or required apparatus to trigger an emergency situation.

The current documented invention on the other hand, is capable of automatically triggering an emergency notification upon the end of the event time providing adequate details of the emergency event and the location (subject to one's wireless device is subscribe to the location base service, such as GPS service) of the individual without any action explicitly from the individual during the emergency distress situation or when one is in a situation where he cannot access to his wireless device.

### SUMMARY OF INVENTION

This method and system is a personal protection solution which leverages on SMS technology but not limiting to this technology alone to provide a ‘security-guard’ for the subscriber.

The concept relates to anticipating and registering any potential vulnerable event and the system will automatically alert the right people for assistance.

One of the main benefit of this is that when one is indeed faced with any harm or trouble and the situation does not permit one to call for help or push any emergency button, this service will automatically triggered an alert and send an emergency message together with one's probable location to a group of predefine people for help. The method also does not dependent on any additional devices, apparatus or sensors in order to trigger the emergency alert.

Let's paint a few scenarios when the service is crucial.

Scenario 1:

When you board a cab and half way through, the cab driver pick up another person and you are caught in a cab, not being to make any emergency call/SMS and cannot escape, wouldn't you wish that someone is aware and will come for rescue?

Scenario 2:

When you are out with someone and suddenly you realized that the person cannot be trusted but yet you can't seem to escape or excuse yourself, wouldn't you wish that you have notified someone and he is aware that you need help?

Scenario 3:

When your daughter tells you that she is going for her tuition class but along the way something undesirable happened and can't call for help, wouldn't you as the parents want to know?

In all the above scenarios, if the activity has been registered as an emergency event and the system does not receive a safety confirmation reply by the end of the event end time, the system would then automatically send an emergency notification via SMS, but not limited to only this channels notifying the emergency contacts that an undesirable event had occurred with information on the where about of your love ones.

In order for this service to provide near ‘full-prove’ protection to an individual, one has to cultivate the habit of registering all activities as emergency event and make this as a daily routine especially when one is going somewhere alone. To relieve the individual the hassles to input all the required information, standard routine templates are provided where one can just choose and register the event with minimal input.

### BRIEF DESCRIPTION OF THE DRAWINGS

FIG. 1: Provides an overview of the personal protection system from the registration of an event to the emergency notification using different channels and media.

FIG. 2: Illustrates the process workflow diagram of first time registration of the service

FIG. 3: Illustrates the process workflow diagram how one register for an emergency event

FIG. 4: Illustrated the process workflow diagram of how the system continues to track the safety of the person and his location and automatically triggered emergency alert for help.

FIG. 5: Illustrated the process workflow diagram of second level notification to third party or authority systems.

### DETAILED DESCRIPTION OF THE PREFERRED EMBODIMENTS

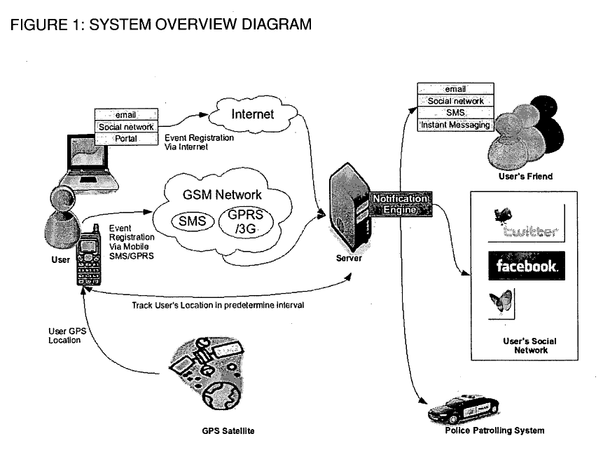

FIG. 1 demonstrates the logical diagram flow of an individual performing registration of an emergency event using various channels such as email, web portal, and wireless network using SMS, 3G, GPRS or mobile device. Upon reaching the predefine end time, the server will send the individual a ‘safety confirmation’ sms and wait for a positive reply within a predetermine timeframe, failing which the server notification engine will then send an emergency alert message to a list of emergency contacts. The same emergency message will also be broadcasted to the subscribers own social service network such as Facebook or Twitter. The system can also continuosly track the user's location using the wireless location base tracking service, e.g GPS technology (subject to the individual's wireless device is subscribed to the service) and send the location together with the emergency notification message. The system can also be integrated to other security networks/systems such as Police Patrolling System or Private Security Network as a second level emergency alert.

Following are the various sub-processes for the end-to-end concept:

1.1 First Time Registration Process

1.2 Event Registration

1.3 Event Triggering & Alert Notification

1.4 Post Alert Notification

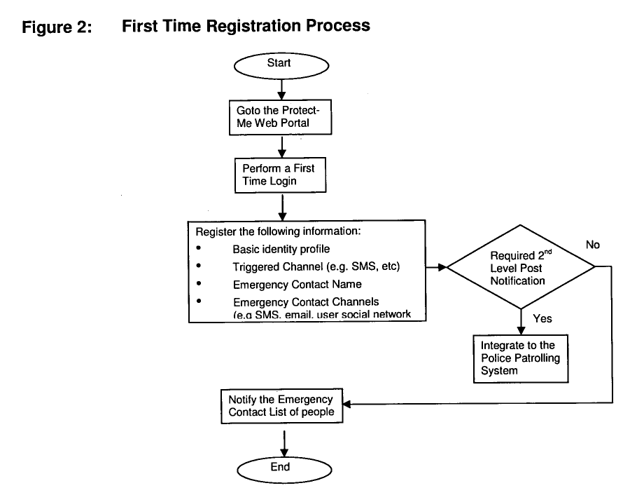

1.1 First Time Registration Process (Please refer to FIG. 2)

1.1.1 An individual will first subscribe for the service through a web portal or via any other channels such as via his mobile phone using SMS, email, facsimile, etc.

1.1.2 One will then furnish information relating to the channel and media which he would like to register his future emergency events. We name this channel, the ‘triggered channel’. Example of a channel is SMS (but not limiting to only this channel), where one will then tagged the wireless device which one will use to register his future event. It can be the subscriber's own wireless device or any third party wireless device. Example a mother registering her daughter wireless device for this service.

1.1.3. This is follow by information of the emergency contacts names' and details such as the channels which they will receive the emergency alert. The emergency contacts can comprise of one or many people or even different groups of people making up of friend or relatives. The channels can be in the form of SMS, email and user social network account such as Face Book, Twitter and etc. Once successful performing the first time registration, all emergency contacts will receive a notification from the system either through various means and media.

1.1.4 There is also a second level of emergency notification to 3^{rd} party emergency services which will be further elaborated in Section 1.4 Post Alert Notification.

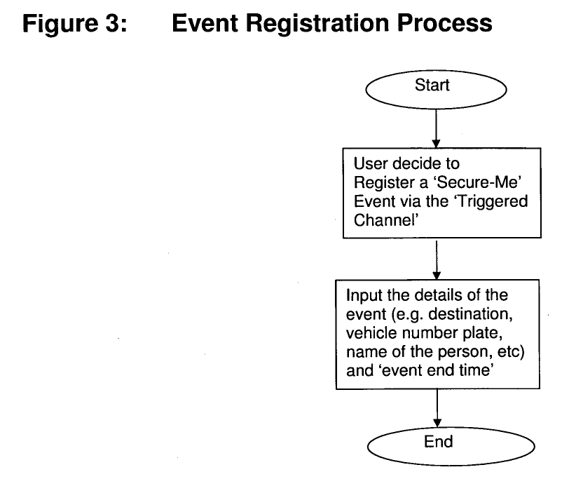

1.2 Event Registration (Please refer to FIG. 3)

1.2.1 At any point of time, the subscriber can register an emergency event via the registered ‘triggered channel’ with details of the event follow-by the anticipated event end time.

1.2.2 Example of an event is when one boards a cab to go to a specific destination within certain duration. One can then registered the ‘secure-me’ event as ‘Boarding a cab, AAA1234 to Hotel ABC. Estimated arrival time 1 μm’

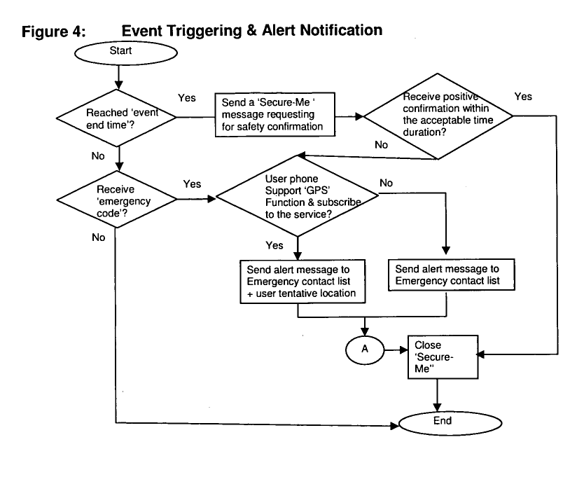

1.3 Event Triggering & Alert Notification (Please refer to FIG. 4)

1.3.1 There are two methods to trigger an event.

1.3.2 The first method is triggered upon the event end time. The server will send a SMS message to the individual wireless device (but not limiting to this channel alone) requesting for confirmation of his safety. If the server does not receive any positive response within a specific time duration, the server will automatically send an emergency alert to the ‘Emergency contact list’ via the predefined channels earlier.

1.3.3 The second method is for the person to send an ‘emergency code’ via SMS using his wireless device or any channels that the individual can access to and upon receiving the ‘emergency code’, the server will also automatically send an emergency alert to the ‘Emergency contact list’ via the predefined channels earlier.

1.3.4 The system is design to also detect the person tentative where about using any location base tracking capability (such as GPS) should the person's wireless device support and subscribe to the service. Also the individual wireless device number must first be captured during enrollment.

1.3.5 However, if the server receive a positive response within the certain timeframe then, the emergency event will be considered closed. One can also extend the duration of the same ‘secure-me’ event confirming the transaction with the ‘emergency code’ if the event is still not completed or one still has not arrive at the destination.

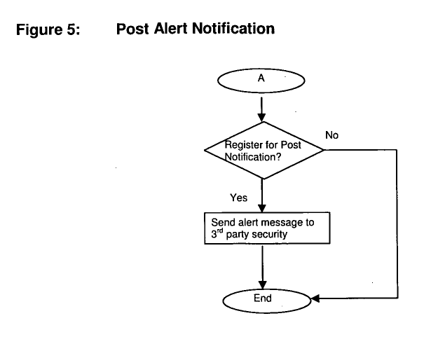

Post Alert Notification (Please refer to FIG. 5)

1.4.1 One can also choose whether to notify the authority or any third party emergency services as a second level of alert notification on top of the ‘emergency contact list’ after a predefined duration.

1.4.2 If one chooses for second level notification, the system will triggered an alert to an additional integration link to the Authorised Authority such as Policy patrolling department to report the potential undesirable event so that additional help can be given.

Following Table Describe the Messages that one would send and receive.

| | | Main Contents of | |
|---|---|---|---|
| | | the Message | |
| | | Note: This is not the | |
| | Source of | complete format of | Purpose of the |
| Message Type | Initiation | the message | Message |
| ‘Emergency | System | Notification | Providing ‘heads-up’ and |
| contacts’ | generated | message as | courtesy notification to |
| notification | message to the | ‘emergency | the group of predefined |
| message | list of emergency | contacts’ | people notifying them |
| | contacts via | | that they have been |
| | various channels | | nominated by the user |
| | | | as ‘emergency contacts’ |
| | | | for this service to |
| | | | prevent |
| | | | misunderstanding of |
| | | | receiving ‘spamming’ |
| | | | emails/sms. |
| ‘Secure-me’ Event | User Initiated via | Details of the event | Providing details of the |
| Registration | his Wireless | Event End Time | event (E.g. Cab Number |
| Message | Device or any | | Plate, Starting Location |
| | other user | | and Destination, Name |
| | defined channels. | | of the person, Activity) |
| | | | and the anticipated |
| | | | arrival time or end time |
| | | | of the event |
| ‘Secure-me’ Event | System | Event | To provide user an |
| Registration | generated | Acknowledgement | acknowledgement of the |
| Acknowledgement | message to user | | successful registration of |
| Message | defined channels | | an event. |
| ‘Safety | System triggered | Event Termination | Seeking confirmation on |
| Confirmation’ | message to user | Confirmation | the safety of the person |
| Message | defined channels | message | and termination of the |
| | | | event |
| ‘Secure-me Event | 2 options: | Emergency Code | For user to revise the |
| Extension | 1. User Initiated | Revised Extension | event end time should in |
| Message’ | via his Wireless | Time | the event that the |
| | Device or any | | journey takes longer |
| | other user | | than the original |
| | defined channels | | expected end time. |
| | before the | | |
| | original event end | | |
| | time | | |
| | 2. User to trigger | | |
| | the extension | | |
| | time at the point | | |
| | of receiving the | | |
| | safety | | |
| | confirmation | | |
| | message from | | |
| | the system | | |
| Emergency Alert | | Details of the event | The emergency |
| Message | | Event End Time | notification message |
| | | Possible Location | that will be send to the |
| | | | emergency contacts and |
| | | | broadcasted to the |
| | | | individual own social |
| | | | network services in the |
| | | | event of an emergency |

Key Features
System will automatically alert a group of predefined group of different people via various channels and media when an emergency event occurred even if situation at that point of time does not allow the person to react or call for help.
Able to integrate with various mobile technology, email, social network such as Facebook and Twitter and automatically broadcast the emergency messages to the individual own social network or to the social network of the predefined group of emergency contact.
Flexibility of allowing a subscriber to register an emergency event with free text input message with sufficient details via SMS but not limited to this channel alone
System will be able to continue to locate and detect the person tentative where about using location base tracking technology should the person's mobile phone support and subscribe to the service and provide this as a web-base tracking system to facilitate the rescue operation if needed be.
Two methods of triggering an emergency event, either system proactively triggering based on the pre-set event end time or reactively when a user submit an emergency code to the server via SMS upon an emergency.
The service enables a second level of emergency notifications to third part or any online authorized party such as policy patrolling system.
To help cultivate the habit of the individual in registering all activities as emergency event in their daily routine, standard event templates are made available to ease the registration process where the individual only needs to choose the right template and register. No further input is required unless when there is a change of event end time.
System will automatically notify the ‘emergency contacts’ upon a successful registering of the list of emergency contacts by user so as to provide a ‘heads-up’ and a courtesy notification that they are the nominated emergency contacts for the user who has register for this service to prevent any misunderstanding that this is a spam message.

1-19. (canceled)

20. A system to automatically deliver at least one emergency message through at least one channel of communication to a group of people, the system includes:
a) at least one communication device used by at least one user;
b) at least one server; and
c) a wireless tracking service;
wherein the wireless tracking service is used to locate the least one user by tracking the at least one communication device;
wherein the at least one communication device is used by the at least one user for registering the at least one channel of communication;
wherein the at least one communication device is used for registering at least one emergency event and assigning a period of time to end the at least one emergency event;
wherein the at least one server stores information of the at least one channel of communication;
wherein the at least one server stores the at least one emergency event and the assigned period of time to end the at least one emergency event;
wherein the at least one server requests for confirmation of safety from the at least one user upon expiry of the assigned period of time;
wherein the at least one server delivers the at least one emergency message to the at least one channel of communication if the at least one user does not send confirmation of safety.

21. The system as claimed in claim 20 wherein the at least one communication device is subscribed to a preferred telephone network provider.

22. The system as claimed in claim 20, wherein the wireless tracking service sends the at least one user's location and coordinates to the at least one channel of communication.

23. The system as claimed in claim 22 wherein the wireless tracking service continues tracking the at least one communication device until the confirmation of safety is received.

24. The system as claimed in claim 23 wherein the wireless tracking service includes an access mechanism to allow tracking of the at least one communication device after confirmation of safety is received.

25. The system as claimed in claim 20 wherein the at least one communication channel is notified of nomination as emergency contact through the at least one server during registration.

26. The system as claimed in claim 20 wherein the at least one communication channel includes mobile device.

27. The system as claimed in claim 20 wherein the at least one communication channel includes social network.

28. A method to automatically deliver at least one emergency message to at least one channel of communication, the method includes the steps of:
a) registering at least one user;
b) initiating at least one emergency event;
c) assigning a period of time to end the at least one emergency event;
d) requesting a confirmation of safety automatically by the at least one server upon expiry of the assigned period of time; and
e) delivering the at least one emergency message to the at least one channel of communication if no confirmation of safety is received from the at least one user.

29. The method as claimed in claim 28 wherein the at least one emergency event is initiated by the at least one user by including the at least one emergency event's details including destination and/or mode of transportation.

30. The method as claimed in claim 28 further includes the steps of:
a) tracking location of the at least one user using a wireless tracking service; and
b) sending the location and coordinates of the at least one user to the at least one channel of communication.

31. The method as claimed in claim 30 wherein the location of the at least one user is tracked by tracking the at least one communication device wherein the at least one communication device is subscribed to a preferred telephone network provider.

32. The method as claimed in claim 30 wherein the tracking is continued until the at least one user sends the confirmation of safety.

33. The method as claimed in claim 30 wherein tracking of the at least one user after confirmation of safety is received is allowed by an access mechanism.

34. The method as claimed in claim 28 wherein the registration of the at least one user includes the steps of:
a) inputting personal details of the at least one user;
b) inputting details of the at least one channel of communication to deliver the at least one emergency message; and
c) sending a notification message to the at least one channel of communication to notify nomination by the at least one user.

35. A method to automatically deliver at least one emergency message to at least one channel of communication, the method includes the steps of:
a) registering at least one user;
b) initiating at least one emergency event;
wherein the at least one emergency event is initiated by the at least one user; and
c) delivering the at least one emergency message to the at least one channel of communication.

36. The method as claimed in claim 35 further includes the steps of:
a) tracking location of the at least one user using a wireless tracking service; and
b) sending the location and coordinates of the at least one user to the at least one channel of communication.

37. The method as claimed in claim 36 wherein the location of the at least one user is tracked by tracking the at least one communication device wherein the at least one communication device is subscribed to a preferred telephone network provider.

38. The method as claimed in claim 35 wherein the registration of the at least one user includes the steps of:
a) inputting personal details of the at least one user;
b) inputting details of the at least one channel of communication to deliver the at least one emergency message; and
c) sending a notification message to the at least one channel of communication to notify nomination by the at least one user.
